(19) United States
(12) Patent Application Publication
(10) Pub. No.: US 2024/0392118 A1
(43) Pub. Date: Nov. 28, 2024

(54) POLYMER COMPOSITION

(71) Applicant: BOREALIS AG, Vienna (AT)

(72) Inventors: Thomas GKOURMPIS, Stenungsund (SE); Per-Ola HAGSTRAND, Stenungsund (SE); Azadeh SOROUDI, Göteborg (SE); Yingwei OUYANG, Göteborg (SE); Christian MUELLER, Göteborg (SE); Xiangdong XU, Mölndal (SE); Fritjof NILSSON, Stockholm (SE); Mikael HEDENQVIST, Saltsjöbaden (SE)

(21) Appl. No.: 18/694,578

(22) PCT Filed: Sep. 22, 2022
(86) PCT No.: PCT/EP2022/076331

§ 371 Date: Mar. 22, 2024

(30) Foreign Application Priority Data
Sep. 24, 2021 (EP) 21198795.3

(51) Int. Cl. C08L 23/06; C08J 3/20; C08K 9/06

(52) U.S. Cl. CPC C08L 23/06; C08J 3/203; C08K 9/06; C08J 2323/06; C08J 2423/12; C08J 2453/02; C08K 2201/019; C08L 2205/02; C08L 2207/066

(57) ABSTRACT

A polymer composition comprising (i) 4.95 to 95.0 wt. % low density polyethylene (LDPE) (component (i), herein after); (ii) 4.95 to 95.0 wt. % of a polypropylene (component (ii), herein after); and (iii) 0.00 to 30.0 wt. % of a styrene block copolymer (component (iii), herein after); (iv) 0.05 to 10.0 wt. % of an aliphatic, preferably alkyl, functionalized inorganic nanoparticle filler (component (iv), herein after); whereby the weight percentages (wt. %) are expressed relative to the total weight of the polymer composition.

The present invention relates to a polymer composition with advantageously low direct current (DC) electrical conductivity. In particular, the invention relates to a polymer composition comprising a blend of a low density polyethylene (LDPE), a polypropylene, optionally a styrene block copolymer and an aliphatic functionalized inorganic nanoparticle filler, as well as the use of this composition in the manufacture of cables, especially in the manufacture of the insulation layer of a power cable. Ideally, compositions and cables of the invention are free of peroxides. The invention also relates to processes for preparing such cables.

### BACKGROUND

Polyolefins produced in a high-pressure (HP) process are widely used in demanding polymer applications, for instance power cable applications, wherein the polymers must meet high mechanical and/or electrical requirements. A typical power cable comprises a conductor surrounded, at least, by an inner semiconductive layer, an insulation layer and an outer semiconductive layer. The cables are commonly produced by extruding the layers on a conductor. The polymer material in one or more of said layers is then often crosslinked.

Particularly in medium voltage (MV) and especially in high voltage (HV) and extra high voltage (EHV) cable applications, the electrical properties of the polymer composition have a significant importance. Furthermore, the electrical properties of importance may differ in different cable applications, as is the case between alternating current (AC) and direct current (DC) cable applications.

The DC electrical conductivity is an important material property, for example for the insulating materials in high voltage direct current (HVDC) cables. Firstly, the strong temperature and electric field dependence of this property will influence the electric field. The second issue concerns the heat generated inside the insulation by the electric leakage current flowing between the inner and outer semiconductive layers. This leakage current depends on the electric field and the electrical conductivity of the insulation.

Accordingly, in HVDC cables, the insulation is partly heated by the leakage current. For a specific cable design, the heating is proportional to the insulation conductivity×voltage².

There are high demands to increase the voltage of direct current (DC) power cables. In HVDC power cables, raising the voltage level offers the possibility to either increase the power transmission capacity and/or reduce losses. However, if the voltage is increased, more heat will be generated. This may lead to thermal runaway followed by electric breakdown. Hence, in order to further increase the voltage level of HVDC cables, insulation materials with lower DC conductivity are needed.

WO2017/149086 & WO2017/149087 relate to the use of nanoparticle fillers in polymer compositions. However, the use of said fillers in blends of a low density polyethylene (LDPE), a polypropylene and optionally a styrene block copolymer is not disclosed, and the conductivity of the exemplified compositions is still relatively high.

EP3261095 relates to a cable comprising a polymer composition comprising a blend of LDPE and HDPE. The use of nanoparticle fillers is however not disclosed, and the conductivity of the exemplified compositions is still relatively high.

Hence, there remains a need therefore for new polymer compositions having further reduced DC conductivity while the polymer compositions should also have sufficiently good mechanical properties required for demanding power cable applications. Additionally, there is a need for new polyolefin compositions which avoid the disadvantages associated with peroxides, but which also offer attractive properties.

Often, the polymer material in one of the semiconductive layers and/or the insulation layer is crosslinked to improve for example heat and deformation resistance, creep properties, mechanical strength, chemical resistance and abrasion resistance. Crosslinking can be effected using e.g. a free radical generating compound which is typically incorporated into the layer material prior to the extrusion of the layer(s) on a conductor. After formation of the layered cable, the cable is then subjected to a crosslinking step to initiate the radical formation and thereby crosslinking reaction.

Peroxides are very commonly used as free radical generating compounds. Crosslinking using peroxides suffers from some disadvantages, however. For example, low-molecular by-products are formed during crosslinking which have an unpleasant odour. These decomposition products of peroxides may include volatile by-products which are often undesired, since they may have a negative influence on the electrical properties of the cable. Therefore, the volatile decomposition products such as methane are conventionally reduced to a minimum or removed after crosslinking and a cooling step. Such a removal step, generally known as a degassing step, is time and energy consuming causing extra costs.

Thermoplastic insulation materials can offer several advantages. The elimination of crosslinking and degassing steps can lead to faster, less complicated and more cost effective cable production. The process is faster and cleaner in terms of extruder output and reduced cleaning interruptions. However, the absence of a cross-linked material can lead to a reduced dimensional stability at elevated temperatures.

The possibility of using non cross-linked LDPE in the insulation layer of a cable is not new. In WO2011/113685, LDPE of density 922 kg/m³ and MFR₂ 1.90 g/10 min is suggested for use in the insulation layer of a cable. WO2011/113685 also suggests using other polymers individually in the non-cross-linked insulation layer of a cable.

In view of the above, there remains a need therefore for new polymer compositions having further reduced DC conductivity which avoid the disadvantages associated with peroxides, while the polymer compositions should also have sufficiently good mechanical properties.

### SUMMARY OF THE INVENTION

It is the object of the present invention to provide a new polyolefin composition exhibiting reduced DC conductivity while still providing such properties suitable for use in demanding power cable applications without using peroxides at all.

The present inventors have now established that a polymer composition comprising a blend of a low density polyethylene (LDPE), a polypropylene, optionally a styrene block copolymer and an aliphatic functionalized inorganic nanoparticle filler has surprisingly low DC conductivity, thereby being particularly suitable for use in the manufacture of high voltage power cables.

Although it is known that agglomerates, or aggregates of nanoparticles may lead to early cable breakdown, the inventors have found that the claimed combination of components gives rise to an exceptionally low DC conductivity and advantageously does not require the use of peroxide to initiate a crosslinking.

Thus, in one aspect the invention provides a polymer composition comprising: (i) 4.95 to 95.0 wt. % low density polyethylene (LDPE);
(ii) 4.95 to 95.0 wt. % of a polypropylene; and
(iii) 0.00 to 30.0 wt. % of a styrene block copolymer;
(iv) 0.05 to 10.0 wt. % of an aliphatic, preferably alkyl, functionalized inorganic nanoparticle filler;
whereby the weight percentages (wt. %) are expressed relative to the total weight of the polymer composition.

Viewed from another aspect, the invention provides a process for the preparation of a polymer composition as hereinbefore defined, comprising blending:
(i) 4.95 to 95.0 wt. % low density polyethylene (LDPE);
(ii) 4.95 to 95.0 wt. % of a polypropylene; and
(iii) 0.00 to 30.0 wt. % of a styrene block copolymer;
(iv) 0.05 to 10.0 wt. % of an aliphatic, preferably alkyl, functionalized inorganic nanoparticle filler;
whereby the weight percentages (wt. %) are expressed relative to the total weight of the polymer composition.

Viewed from a further aspect, the invention provides a cable comprising a conductor surrounded by one or more layers wherein one or more of said layers comprises a polymer composition as hereinbefore defined. In a still further aspect, the invention provides a power cable, for example a direct current (DC) power cable, comprising a conductor which is surrounded at least by an inner semiconductive layer, an insulation layer and an outer semiconductive layer, in that order, wherein at least one layer, for example at least the insulation layer, comprises a polymer composition as hereinbefore defined.

Viewed from a still further aspect, the invention provides the use of a polymer composition as hereinbefore defined in the manufacture of a layer in a cable, preferably a power cable, more preferably the insulation layer of a power cable.

Viewed from another aspect, the invention provides the use of a polymer composition as hereinbefore defined in the manufacture of a recycled insulation layer in a cable, preferably a power cable.

### Definitions

Wherever the term “molecular weight M_{w}” is used herein, the weight average molecular weight is meant.

The term “polyethylene” will be understood to mean an ethylene based polymer, i.e. one comprising at least 50 wt. % ethylene, based on the total weight of the polymer as a whole. The terms “polyethylene” and “ethylene-based polymer,” are used interchangeably herein, and mean a polymer that comprises a majority weight percent polymerised ethylene monomer (based on the total weight of polymerisable monomers), and optionally may comprise at least one polymerised comonomer. The ethylene-based polymer may include greater than 50, or greater than 60, or greater than 70, or greater than 80, or greater than 90 weight percent units derived from ethylene (based on the total weight of the ethylene-based polymer).

The term “polypropylene” will be understood to mean a propylene based polymer, i.e. one comprising at least 50 wt. % propylene, based on the total weight of the polymer as a whole.

The term styrene block copolymer defines a block copolymer comprising several blocks where each block is made with the same type of monomer (or mixture of monomers), but the type of monomer(s) differs between blocks.

Non cross-linked polymer compositions or cable layers are regarded as thermoplastic.

The polymer composition of the invention may also be referred to as a polymer blend herein. These terms are used interchangeably.

The low density polyethylene, LDPE, of the invention is a polyethylene produced in a high pressure process. Typically the polymerisation of ethylene and optional further comonomer(s) in a high pressure process is carried out in the presence of an initiator(s). The meaning of the term LDPE is well known and documented in the literature. The term LDPE describes and distinguishes a high pressure polyethylene from low pressure polyethylenes produced in the presence of an olefin polymerisation catalyst. LDPEs have certain typical features, such as different branching architecture. A typical density range for an LDPE is 0.910 to 0.940 g/cm³.

The term “conductor” means herein a conductor comprising one or more wires. The wire can be for any use and be e.g. optical, telecommunication or electrical wire. Moreover, the cable may comprise one or more such conductors. Preferably the conductor is an electrical conductor and comprises one or more metal wires.

### DETAILED DESCRIPTION OF THE INVENTION

The present invention relates to a polymer composition comprising:
(i) 4.95 to 95.0 wt. % low density polyethylene (LDPE);
(ii) 4.95 to 95.0 wt. % of a polypropylene; and
(iii) 0.00 to 30.0 wt. % of a styrene block copolymer;
(iv) 0.05 to 10.0 wt. % of an aliphatic, preferably alkyl, functionalized inorganic nanoparticle filler;
whereby the weight percentages are expressed relative to the total weight of the polymer composition.

It is understood that the amount of components (i) to (iv) in the composition may be varied independently.

The invention also relates to cables in which at least one layer thereof comprises this polymer composition. In all embodiments, the polymer composition or the layer of the cable in question is ideally free of peroxide.

The polymer composition may optionally be crosslinked. In a preferred embodiment, the polymer composition is not crosslinked. A “non-crosslinked” polymer composition means that the polymer composition in its final form e.g. in a layer of a cable, is not crosslinked and is hence thermoplastic The following preferred definitions of LDPE, polypropylene and styrene block copolymer apply to all aspects of the invention unless otherwise stated.

Component (i)—Low-Density Polyethylene (LDPE)

Component (i) of the polymer composition according to the present invention is a low-density polyethylene (LDPE).

The low density polyethylene (LDPE) is an ethylene-based polymer. The term, “ethylene-based polymer,” as used herein, is a polymer that comprises a majority weight percent polymerised ethylene monomer (based on the total weight of polymerisable monomers), and optionally may comprise at least one polymerised comonomer. The ethylene-based polymer may include greater than 50, or greater than 60, or greater than 70, or greater than 80, or greater than 90 weight percent units derived from ethylene (based on the total weight of the ethylene-based polymer).

The LDPE may be a low density homopolymer of ethylene (referred herein as LDPE homopolymer) or a low density copolymer of ethylene with one or more comonomer(s) (referred herein as LDPE copolymer). The one or more comonomers of the LDPE copolymer are preferably selected from the polar comonomer(s), nonpolar comonomer(s) or from a mixture of the polar comonomer(s) and non-polar comonomer(s). Moreover, said LDPE homopolymer or LDPE copolymer may optionally be unsaturated. Preferably, the LDPE is a homopolymer.

As a polar comonomer for the LDPE copolymer comonomer(s) containing hydroxyl group(s), alkoxy group(s), carbonyl group(s), carboxyl group(s), ether group(s) or ester group(s), or a mixture thereof, can be used. More preferably, comonomer(s) containing carboxyl and/or ester group(s) are used as said polar comonomer. Still more preferably, the polar comonomer(s) of the LDPE copolymer is selected from the groups of acrylate(s), methacrylate(s) or acetate(s), or any mixtures thereof.

If present in said LDPE copolymer, the polar comonomer(s) is preferably selected from the group of alkyl acrylates, alkyl methacrylates or vinyl acetate, or a mixture thereof. Further preferably, said polar comonomers are selected from C1- to C6-alkyl acrylates, C1- to C6-alkyl methacrylates or vinyl acetate. Still more preferably, said LDPE copolymer is a copolymer of ethylene with C1- to C4-alkyl acrylate, such as methyl, ethyl, propyl or butyl acrylate, or vinyl acetate, or any mixture thereof.

The non-polar comonomer(s) for the LDPE copolymer are preferably selected from monounsaturated (=one double bond) comonomer(s), (such as alpha-olefins, more preferably C3 to C10 alpha-olefins, such as propylene, 1-butene, 1-hexene, 4-methyl-1-pentene, styrene, 1-octene, 1-nonene); polyunsaturated (=more than one double bond) comonomer(s); a silane group containing comonomer(s); or any mixtures thereof. The polyunsaturated comonomer(s) are further described below.

If the LDPE is a copolymer, it preferably comprises 0.001 to 35 wt.-%, still more preferably less than 30 wt.-%, more preferably less than 25 wt.-%, of one or more comonomer(s). Preferred ranges include 0.5 to 10 wt. %, such as 0.5 to 5 wt. % comonomer.

The LDPE polymer, may optionally be unsaturated, i.e. may comprise carbon-carbon double bonds (—C═C—). Preferred “unsaturated” LDPEs contains carbon-carbon double bonds/1000 carbon atoms in a total amount of at least 0.4/1000 carbon atoms. If a non-cross-linked LDPE is used in the final cable, then the LDPE is typically not unsaturated as defined above. By not unsaturated is meant that the C═C content is preferably less than 0.2/1000 carbon atoms, such as 0.1/1000 C atoms or less.

As well known, the unsaturation can be provided to the LDPE polymer by means of the comonomers, a low molecular weight (M_{w}) additive compound, such as a chain transfer agent or scorch retarder additive, or any combinations thereof. The total amount of double bonds means herein double bonds added by any means. If two or more above sources of double bonds are chosen to be used for providing the unsaturation, then the total amount of double bonds in the LDPE polymer means the sum of the double bonds present. Any double bond measurements are carried out prior to optional crosslinking.

The term “total amount of carbon-carbon double bonds” refers to the combined amount of double bonds which originate from vinyl groups, vinylidene groups and trans-vinylene groups, if present.

If an LDPE homopolymer is unsaturated, then the unsaturation can be provided e.g. by a chain transfer agent (CTA), such as propylene, and/or by polymerisation conditions. If an LDPE copolymer is unsaturated, then the unsaturation can be provided by one or more of the following means: by a chain transfer agent (CTA), by one or more polyunsaturated comonomer(s) or by polymerisation conditions. It is well known that selected polymerisation conditions such as peak temperatures and pressure, can have an influence on the unsaturation level. In case of an unsaturated LDPE copolymer, it is preferably an unsaturated LDPE copolymer of ethylene with at least one polyunsaturated comonomer, and optionally with other comonomer(s), such as polar comonomer(s) which is preferably selected from acrylate or acetate comonomer(s). More preferably an unsaturated LDPE copolymer is an unsaturated LDPE copolymer of ethylene with at least polyunsaturated comonomer(s).

The polyunsaturated comonomers suitable as the non-polar comonomer preferably consist of a straight carbon chain with at least 8 carbon atoms and at least 4 carbons between the non-conjugated double bonds, of which at least one is terminal, more preferably, said polyunsaturated comonomer is a diene, preferably a diene which comprises at least eight carbon atoms, the first carbon-carbon double bond being terminal and the second carbon-carbon double bond being non-conjugated to the first one. Preferred dienes are selected from C8 to C14 non-conjugated dienes or mixtures thereof, more preferably selected from 1,7-octadiene, 1,9-decadiene, 1,11-dodecadiene, 1,13-tetradecadiene, 7-methyl-1,6-octadiene, 9-methyl-1,8-decadiene, or mixtures thereof. Even more preferably, the diene is selected from 1,7-octadiene, 1,9-decadiene, 1,11-dodecadiene, 1,13-tetradecadiene, or any mixture thereof, however, without limiting to above dienes.

It is well known that e.g. propylene can be used as a comonomer or as a chain transfer agent (CTA), or both, whereby it can contribute to the total amount of the carbon-carbon double bonds, preferably to the total amount of the vinyl groups. Herein, when a compound which can also act as comonomer, such as propylene, is used as CTA for providing double bonds, then said copolymerisable comonomer is not calculated to the comonomer content.

If LDPE polymer is unsaturated, then it has preferably a total amount of carbon-carbon double bonds, which originate from vinyl groups, vinylidene groups and trans-vinylene groups, if present, of more than 0.4/1000 carbon atoms, preferably of more than 0.5/1000 carbon atoms. The upper limit of the amount of carbon-carbon double bonds present in the LDPE is not limited and may preferably be less than 5.0/1000 carbon atoms, preferably less than 3.0/1000 carbon atoms.

If the LDPE is unsaturated LDPE as defined above, it contains preferably at least vinyl groups and the total amount of vinyl groups is preferably higher than 0.05/1000 carbon atoms, still more preferably higher than 0.08/1000 carbon atoms, and most preferably of higher than 0.11/1000 carbon atoms. Preferably, the total amount of vinyl groups is of lower than 4.0/1000 carbon atoms, more preferably lower than 2.0/1000 carbon atoms. More preferably the LDPE contains vinyl groups in total amount of more than 0.20/1000 carbon atoms, still more preferably of more than 0.30/1000 carbon atoms.

It is however, preferred if the LDPE of the invention is not unsaturated and possesses less than 0.2 C═C/1000 C atoms, preferably less than 0.1 C═C/1000 C atoms. It is also preferred if the LDPE is a homopolymer. As the polymer composition of the invention is not designed for crosslinking, the presence of unsaturation within the LDPE is not required or desired.

The LDPE polymer may have a high melting point, which may be of importance especially for a thermoplastic insulation material. Melting points of 112° C. or more are envisaged, such as 114° C. or more, especially 116° C. or more, such as 112 to 130° C.

The LDPE may have a density of 915 to 940 kg/m3, preferably 918 to 935 kg/m3, especially 920 to 932 kg/m3, such as about 922 to 930 kg/m3.

The MFR₂ (2.16 kg, 190° C.) of the LDPE is preferably from 0.05 to 30.0 g/10 min, more preferably is from 0.1 to 20 g/10 min, and most preferably is from 0.1 to 10 g/10 min, especially 0.1 to 5.0 g/10 min. In a preferred embodiment, the MFR₂ of the LDPE is 0.1 to 4.0 g/10 min, especially 0.5 to 4.0 g/10 min, especially 1.0 to 3.0 g/10 min.

The LDPE may have a weight average molecular weight (M_{w}) of 80 kg/mol to 200 kg/mol, such as 100 to 180 kg/mol.

It is possible to use a mixture of LDPEs in the polymer composition of the invention however it is preferred if a single LDPE is used. If a mixture of LDPEs is used, then the wt. % quoted refer to the total LDPE content present.

The LDPE polymer is produced at high pressure by free radical initiated polymerisation (referred to as high pressure (HP) radical polymerization). The HP reactor can be e.g. a well-known tubular or autoclave reactor or a mixture thereof, preferably a tubular reactor. The high pressure (HP) polymerisation and the adjustment of process conditions for further tailoring the other properties of the LDPE depending on the desired end application are well known and described in the literature and can readily be used by a skilled person. Suitable polymerisation temperatures range up to 400° C., preferably from 80 to 350° C. and pressure from 70 MPa, preferably 100 to 400 MPa, more preferably from 100 to 350 MPa. Pressure can be measured at least after compression stage and/or after the tubular reactor. Temperature can be measured at several points during all steps.

After the separation the obtained LDPE is typically in a form of a polymer melt which is normally mixed and pelletised in a pelletising section, such as pelletising extruder, arranged in connection to the HP reactor system. Optionally, additive(s), such as antioxidant(s), can be added in this mixer in a known manner.

Further details of the production of ethylene (co)polymers by high pressure radical polymerisation can be found i.a. in the Encyclopaedia of Polymer Science and Engineering, Vol. 6 (1986), pp 383-410 and Encyclopaedia of Materials: Science and Technology, 2001 Elsevier Science Ltd.: “Polyethylene: High-pressure, R. Klimesch, D. Littmann and F.-O. Mähling pp. 7181-7184.

It is most preferred if the LDPE is a low density homopolymer of ethylene.

The LDPE in the polymer composition of the invention is preferably present in an amount of 4.95 to 95 wt. %, relative to the total weight of the polymer composition.

In one embodiment, the weight percent of the LDPE in the polymer composition of the present invention, relative to the total weight of the polymer composition, is advantageously equal to or greater than 5.0 wt. %, or equal to or greater than 10.0 wt. %, or equal to or greater than 15.0 wt. %, or equal to or greater than 20.0 wt. %, or equal to or greater than 25.0 wt. %, or equal to or greater than 30.0 wt. %

It is further understood that the upper limit of the weight percent of the LDPE in the polymer composition, relative to the total weight of the polymer composition, is equal to or less than 95.0 wt. %, or equal to or less than 92.5 wt. %, or equal to or less than 90.0 wt. %, or equal to or less than 87.5 wt. %, or equal to or less than 85.0 wt. %, or equal to or less than 82.5 wt. %.

In a preferred embodiment of the polymer composition according to the present invention, the weight percent of the LDPE in the polymer composition, relative to the total weight of the polymer composition, ranges from 10.0 to 90.0 wt. %, or 20.0 to 85.0 wt. %, or 25.0 to 82.5 wt. %. preferably to 80.0 wt. %, such as 25.0 to 80.0 wt. %, or 30.0 to 77.5 wt. %, especially 35.0 to 75.0 wt. % relative to the total weight of the polymer composition as a whole.

The LDPE of the invention is not new and commercially available.

Component (ii)—Polypropylene (PP)

Component (ii) of the polymer composition according to the present invention is a polypropylene.

The polypropylene is a propylene based polymer. The term, “propylene-based polymer,” as used herein, is a polymer that comprises a majority weight percent polymerised propylene monomer (based on the total weight of polymerisable monomers), and optionally may comprise at least one polymerised comonomer. The propylene-based polymer may include greater than 50, or greater than 60, or greater than 70, or greater than 80, or greater than 90 weight percent units derived from propylene (based on the total weight of the propylene-based polymer).

The polypropylene may be a propylene homopolymer or a propylene copolymer. Preferably, the polypropylene is a homopolymer.

In an alternative embodiment, component (ii) comprises a heterophasic polypropylene copolymer, preferably a random heterophasic polypropylene copolymer. The inventors have found that when the polypropylene component (ii) comprises a heterophasic polypropylene copolymer, the presence of component (iii) is of less importance.

Heterophasic polypropylene is a propylene-based copolymer with a semi-crystalline matrix phase, which can be a propylene homopolymer or a random copolymer of propylene and at least one alpha-olefin comonomer, and an elastomeric phase dispersed therein. The elastomeric phase can be a propylene copolymer with a high amount of comonomer, which is not randomly distributed in the polymer chain but are distributed in a comonomer-rich block structure and a propylene-rich block structure.

A heterophasic polypropylene usually differentiates from a one-phasic propylene copolymer in that it shows two distinct glass transition temperatures T_{g} which are attributed to the matrix phase and the elastomeric phase.

The comonomer may be α-olefin such as ethylene or a C4-20 linear, branched or cyclic α-olefin. Nonlimiting examples of suitable C4-20 α-olefins include 1-butene, 4-methyl-1-pentene, 1-hexene, 1-octene, 1-decene, 1-dodecene, 1-tetradecene, 1-hexadecene, and 1-octadecene. The α-olefins also can contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, for purposes of this disclosure certain cyclic olefins, such as norbornene and related olefins, particularly 5-ethylidene-2-norbornene, are α-olefins and can be used in place of some or all of the α-olefins described above. Similarly, styrene and its related olefins (for example, α-methylstyrene, etc.) are α-olefins for purposes of this disclosure. Illustrative propylene polymers include ethylene/propylene, propylene/butene, propylene/1-hexene, propylene/1-octene, propylene/styrene, and the like. Illustrative terpolymers include ethylene/propylene/1-octene, ethylene/propylene/butene, propylene/butene/1-octene, ethylene/propylene/diene monomer (EPDM) and propylene/butene/styrene. The copolymers can be random copolymers.

In a particularly preferred embodiment, the polypropylene is a homopolymer such as a syndiotactic, or most preferably, an isotactic propylene homopolymer. The isotactic propylene homopolymer used may be one that is capacitor grade.

Typically, the polypropylene has an MFR₂ of from 0.1 to 100 g/10 min, preferably from 0.5 to 50 g/10 min as determined in accordance with ISO 1133 (at 230° C.; 2.16 kg load). Most preferably, the MFR₂ is in the range of 1.0 to 5.0 g/10 min, such as 1.5 to 4.0 g/10 min.

The density of the polypropylene may typically be in the range 890 to 940 kg/m3, ideally 0.895 to 0.920 g/cm³, preferably from 0.900 to 0.915 g/cm³, and more preferably from 0.905 to 0.915 g/cm³ as determined in accordance with ISO 1183. The propylene may have an M_{w} in the range of 200 kg/mol to 600 kg/mol. The polypropylene polymer preferably has a molecular weight distribution M_{w}/Mₙ, being the ratio of the weight average molecular weight M_{w} and the number average molecular weight Mₙ, of less than 4.5, such as 2.0 to 4.0, e.g. 3.0.

Usually the melting temperature of the polypropylene is within the range of 135 to 170° C., preferably in the range of 140 to 168° C., more preferably in the range from 142 to 166° C. as determined by differential scanning calorimetry (DSC) according to ISO 11357-3. Ideally, the polypropylene has a melting temperature (Tm) of greater than 140° C., preferably greater than 150° C.

The polypropylene may be prepared by any suitable known method in the art or can be obtained commercially.

It is possible to use a mixture of polypropylenes in the polymer composition of the invention however it is preferred if a single polypropylene is used. If a mixture of polypropylenes is used, then the wt. % quoted refer to the total polypropylene content present.

The polypropylene in the polymer composition of the invention is preferably present in an amount of 4.95 to 95 wt. %, relative to the total weight of the polymer composition.

In one embodiment, the weight percent of the polypropylene in the polymer composition of the present invention, relative to the total weight of the polymer composition, is advantageously equal to or greater than 5.0 wt. %, or equal to or greater than 7.5 wt. %, or equal to or greater than 10.0 wt. %, or equal to or greater than 12.5 wt. %, or equal to or greater than 15.0 wt. %, or equal to or greater than 17.5 wt. %, or equal to or greater than 20.0 wt. %.

It is further understood that the upper limit of the weight percent of the polypropylene in the polymer composition, relative to the total weight of the polymer composition, is equal to or less than 95.0 wt. %, or equal to or less than 90.0 wt. %, or equal to or less than 80.0 wt. %, or equal to or less than 70.0 wt. %, or equal to or less than 60.0 wt. %, or equal to or less than 50.0 wt. %, or equal to or less than 45.0 wt. %, or equal to or less than 40.0 wt. %.

In a preferred embodiment of the polymer composition according to the present invention, the weight percent of the polypropylene in the polymer composition, relative to the total weight of the polymer composition, ranges from 5.0 to 85.0 wt. %, or 10.0 to 80.0 wt. %, or 15.0 to 70.0 wt. %. preferably to 60.0 wt. %, such as 15.0 to 50.0 wt. %, or 17.5 to 45.0 wt. %, especially 20.0 to 40.0 wt. % relative to the total weight of the polymer composition as a whole.

The polypropylene of the invention is not new. These polymers are readily available from polymer suppliers. For example, Borealis grade Borclean™ HC300BF is suitable for use in the present invention.

Component (iii)—Styrene Block Copolymer

Component (iii) of the polymer composition according to the present invention is a styrene block copolymer.

The styrene block copolymer is a block copolymer comprising styrene monomers and one or more other comonomer(s). The term “block copolymer” will be well known to the skilled person to refer to a copolymer comprising blocks of different polymerised monomers. A block copolymer comprises a plurality of blocks where each block is made with the same type of monomer (or mixture of monomers), but the type of monomer(s) differs between blocks.

The comonomer(s) may be monounsaturated (=one double bond) comonomer(s), preferably olefins, more preferably alpha-olefins, even more preferably C2 to C10 alpha-olefins, such as ethylene, propylene, 1-butene, 1-hexene, 4-methyl-1-pentene, 1-octene, 1-nonene; polyunsaturated (=more than one double bond) comonomer(s), preferably consisting of a straight or branched carbon chain with at least 4 carbon atoms and at least one terminal double bond, more preferably a diene, such as butadiene or isoprene; or mixtures thereof.

In one embodiment, the styrene block copolymer is a terpolymer, i.e. comprising three different monomers (styrene together with two different comonomers).

It is especially preferred that the styrene block copolymer is selected from the group consisting of a styrene-ethylene/butylene-styrene (SEBS) block copolymer, a styrene-ethylene/propylene-styrene (SEPS) block copolymer, a styrene-butadiene-styrene (SBS) block copolymer and a styrene-isoprene-styrene (SIS) block copolymer or mixtures thereof. Most preferably, the styrene block copolymer is a styrene-ethylene/butylene-styrene (SEBS) block copolymer.

The styrene block copolymer may have a styrene content of equal or below 40 wt.-%, more preferably of equal or below 35 wt-%, yet more preferably of equal or below 30 wt.-%. On the other hand the styrene content in the styrene block copolymer, should not fall below 10 wt.-%. Thus a preferred range is of 10 to 40 wt.-%, more preferred of 12 to 35 wt.-% and yet more preferred of 15 to 30 wt.-%.

Further it is appreciated that the styrene block copolymer preferably has a melt flow rate MFR₅ (230° C./5.0 kg) of at least 0.1 g/10 min, more preferably of at least 0.2 g/10 min, still more preferably of at least 0.5 g/10 min. On the other hand the melt flow rate MFR₅ (230° C./5.0 kg) of the styrene block copolymer is preferably not more than 30 g/10 min. Accordingly, a preferred melt flow rate MFR₅ (230° C./5.0 kg) is in the range of 0.1 to 30 g/10 min, more preferred of 0.2 to 25 g/10 min, still more preferred of 0.5 to 20 g/10 min.

The styrene block copolymer may also be defined by its density, which is preferably equal or below 0.950 g/cm³, more preferred equal or below 0.940 g/cm³. Typically, the density of the styrene block copolymer is at least 0.900 g/cm³, more preferred equal or below 0.910 g/cm³.

The styrene block copolymer may be prepared by any suitable known method in the art or can be obtained commercially.

It is possible to use a mixture of styrene block copolymers in the polymer composition of the invention however it is preferred if a single styrene block copolymer is used. If a mixture of styrene block copolymers is used, then the wt. % quoted refer to the total styrene block copolymer content present. In an advantageous embodiment of the present invention, the styrene block copolymer is present and primarily used as a compatibilizer to aid the mixing of the LDPE and polypropylene components. The styrene block copolymer reduces phase separation, and results in blends with advantageous thermomechanical properties. Moreover, the inclusion of the styrene block copolymer may also offer reduced DC conductivity. The lower DC conductivity may allow higher operating temperature of power cables, which in principle can allow higher transmission capacity.

In one embodiment of the present invention, the polymer composition does not comprise a styrene block copolymer (iii) as defined above.

In an advantageous embodiment of the present invention, the styrene block copolymer (iii) is present in the polymer composition. The inventors have found that, although not essential, the styrene block copolymer may act as a compatibilizer to aid the mixing of the LDPE and polypropylene components. The styrene block copolymer reduces phase separation, and results in blends with advantageous thermomechanical properties. Moreover, the inclusion of the styrene block copolymer may also offer reduced DC conductivity. The lower DC conductivity may allow higher operating temperature of power cables, which in principle can allow higher transmission capacity.

The styrene block copolymer (iii) in the polymer composition of the invention is preferably present in an amount of 0.0 to 30.0 wt. %, relative to the total weight of the polymer composition.

In one embodiment, the weight percent of the styrene block copolymer (iii) in the polymer composition of the present invention, relative to the total weight of the polymer composition, is advantageously equal to or greater than 0.5 wt. %, or equal to or greater than 1.0 wt. %, or equal to or greater than 1.5 wt. %, or equal to or greater than 2.0 wt. %, or equal to or greater than 2.5 wt. %, or equal to or greater than 3.0 wt. %, or equal to or greater than 3.5 wt. %, or equal to or greater than 4.0 wt. %.

It is further understood that the upper limit of the weight percent of the styrene block copolymer (iii) in the polymer composition, relative to the total weight of the polymer composition, is equal to or less than 30.0 wt. %, or equal to or less than 25.0 wt. %, or equal to or less than 23.0 wt. %, or equal to or less than 22.0 wt. %, or equal to or less than 21.5 wt. %, or equal to or less than 21.0 wt. %, or equal to or less than 20.5 wt. %, or equal to or less than 20.0 wt. %.

In a preferred embodiment of the polymer composition according to the present invention, the weight percent of the styrene block copolymer (iii) in the polymer composition, relative to the total weight of the polymer composition, ranges from 0.5 to 30.0 wt. %, or 1.0 to 25.0 wt. %, or 2.0 to 23 wt. %. preferably to 22.5 wt. %, such as 3.0 to 22.0 wt. %, or 3.5 to 21.0 wt. %, especially 4.0 to 20.0 wt. % relative to the total weight of the polymer composition as a whole.

If a mixture of styrene block copolymers is used, then these percentages refer to the total amount of all styrene block copolymers.

These polymers are readily available from polymer suppliers. For example, Kraton™ G1642 HU, available from Kraton Corporation, is suitable for use in the present invention.

Component (iv)—Nanoparticle Filler

Component (iv) of the polymer composition according to the present invention is an aliphatic functionalized inorganic nanoparticle filler, preferably an alkyl functionalized inorganic nanoparticle filler. The term “aliphatic functionalized inorganic nanoparticle filler” as used herein refers to an inorganic nanoparticulate filler wherein the nanoparticles have been modified to incorporate one or more aliphatic functionalities at the surface of the nanoparticles. Such modifications are well known in the art and are discussed for example in WO2006/081400. In a preferred embodiment, the aliphatic functionality is an alkyl group, such that the nanoparticle filler is an alkyl functionalized inorganic nanoparticle filler.

The nanoparticles have a diameter of less than 1000 nm, preferably less than 500 nm, especially less than 250 nm. Nanoparticles preferably have a diameter of 10 nm or more, such as 25 nm or more. Nanoparticles preferably have a diameter of 10 to 100 nm, such as 25 to 75 nm. A diameter of 40 to 60 nm is most preferred. These diameters can be determined using TEM analysis.

Component (iv) forms 0.05 to 10% by weight of the overall polymer composition.

In one embodiment, the weight percent of component (iv) in the polymer composition of the present invention, relative to the total weight of the polymer composition, is advantageously equal to or greater than 0.1 wt. %, or equal to or greater than 0.25 wt. %, or equal to or greater than 0.5 wt. %, or equal to or greater than 0.6 wt. %, or equal to or greater than 0.7 wt. %, or equal to or greater than 0.8 wt. %, or equal to or greater than 0.9 wt. %, or equal to or greater than 1.0 wt. %.

It is further understood that the upper limit of the weight percent of the component (iv) in the polymer composition, relative to the total weight of the polymer composition, is equal to or less than 10.0 wt. %, or equal to or less than 9.5 wt. %, or equal to or less than 9.0 wt. %, or equal to or less than 8.5 wt. %, or equal to or less than 8.0 wt. %, or equal to or less than 7.5 wt. %, or equal to or less than 7.0 wt. %, or equal to or less than 6.5 wt. %, or equal to or less than 6.0 wt. %, or equal to or less than 5.5 wt. %, or equal to or less than 5.0 wt. %.

In a preferred embodiment of the polymer composition according to the present invention, the weight percent of the component (iv) in the polymer composition, relative to the total weight of the polymer composition, ranges from 0.05 to 9.5 wt. %, or 0.5 to 9.0 wt. %, or 0.75 to 8.5 wt. %. preferably to 8.0 wt. %, such as 0.8 to 7.5 wt. %, or 0.9 to 6.5 wt. %, especially 1.0 to 5.0 wt. % relative to the total weight of the polymer composition as a whole.

In one embodiment, the nanoparticle filler, component (iv), comprises nanoparticles selected from inorganic oxides, hydroxides, carbonates, fullerenes, nitrides, carbides, kaolin clay, talc, borates, alumina, titania or titanates, silica, silicates, zirconia, zinc oxide, glass fibres or glass particles, or any mixtures thereof.

In one embodiment, the nanoparticle filler comprises inorganic oxide nanoparticles, such as aluminium oxide, magnesium oxide, zinc oxide, silica, titanium oxide, iron oxide, barium oxide, calcium oxide, strontium oxide nanoparticles, or mixtures thereof.

In one embodiment the nanoparticle filler, component (iv), comprises MgO, SiO₂, TiO₂, ZnO, Al₂O₃, Fe₃O₄, barium oxide, calcium oxide, strontium oxide nanoparticles, or mixtures thereof. Preferably the nanoparticle filler comprises aluminium oxide, magnesium oxide, zinc oxide nanoparticles, or mixtures thereof. Most preferably the nanoparticle filler comprises aluminium oxide nanoparticles. In a preferred embodiment the nanoparticle filler comprises Al₂O₃, MgO, ZnO nanoparticles or mixture thereof, most preferably comprises Al₂O₃ nanoparticles.

The nanoparticles forming the nanoparticle filler, component (iv) according to the present invention, are functionalised with aliphatic group(s) such as alkyl, alkenyl, cycloalkyl, alkylcycloalkyl groups. In a preferred embodiment, the aliphatic group(s) is an alkyl group(s), such that the nanoparticle filler is an alkyl functionalized inorganic nanoparticle filler. Said alkyl group(s) is preferably a C1-20 alkyl group, such as a C4-20 alkyl group, preferably C6 to C20 alkyl group. In a preferred embodiment, the alkyl group is a C6 to C12 alkyl group such as a C8 alkyl group.

The aliphatic group(s) may be linear or branched, preferably linear. In a preferred embodiment, the aliphatic group(s) is a linear alkyl group, such as a linear C1-20 alkyl group, especially a linear C4-20 alkyl group. In a preferred embodiment, the alkyl group is a linear C6-12 alkyl group, such as n-octyl.

The nanoparticles forming the nanoparticle filler may be functionalised by any known method. In one embodiment, the nanoparticle filler is functionalised by reaction with an aliphatic-functionalised silane, such as an alkylsilane. The aliphatic group on such a silane is the aliphatic group as described above for the functionalised nanoparticles. In a preferred embodiment, the nanoparticle filler is functionalised by reaction with an alkyl(trialkoxy)silane, dialkyl(dialkoxy)silane or trialkyl(alkoxy)silane, preferably an alkyl(trialkoxy)silane.

The alkyl part of the alkoxy group of the silane may be the same as the alkyl group of the silane or different. In a preferred embodiment, the alkoxy group is a C₁₋₁₀ alkoxy group, especially a linear C₁₋₁₀ alkoxy group, such as methoxy or ethoxy. For example, in one embodiment the nanoparticle filler is functionalised by reaction with an n-octyl(triethoxy)silane, n-octyl(trimethoxy)silane, di(n-octyl)(diethoxy)silane or di(n-octyl)(dimethoxy)silane.

The nanoparticle filler is typically in a solid powder form but can be carried in a medium, such as mineral spirits such as heptane, e.g. such that the mixture of the filler and the carrier forms a colloidal dispersion.

In one embodiment the aliphatic functionalized inorganic nanoparticle filler has a diameter of less than 1000 nm, preferably less than 500 nm, especially less than 250 nm. The aliphatic functionalized inorganic nanoparticle filler preferably has a diameter of 10 nm or more, such as 25 nm or more. The aliphatic functionalized inorganic nanoparticle filler preferably has a diameter of 10 to 100 nm, such as 25 to 75 nm. A diameter of 40 to 60 nm is most preferred.

The reaction between the nanoparticles of the nanoparticle filler and the aliphatic-functionalised silane may be conducted in solution. Suitable solvents are known to the person skilled in the art and include polar and non-polar solvents. In one embodiment, the reaction may be conducted in a solution comprising water, propanol, or mixtures thereof. A catalyst may be used in some embodiments to promote the hydrolysis and condensation of the silanes, for example ammonium hydroxide.

### Optional Further Components

However, additionally, the polymer composition of the invention may contain, in addition to the components (i) to (iv), further component(s) such as polymer component(s) and/or additive(s), for example, additive(s), such as any of antioxidant(s), scorch retarder(s) (SR), crosslinking booster(s), dielectric fluid(s), stabiliser(s), processing aid(s), flame retardant additive(s), water tree retardant additive(s), acid or ion scavenger(s) and voltage stabilizer(s), as known in the polymer field. The polymer composition may comprise, for example, conventionally used additive(s) for wire and cable (W&C) applications, such as one or more antioxidant(s) and optionally one or more of scorch retarder(s) or crosslinking booster(s), for example, at least one or more antioxidant(s). Suitable additives and amounts of additives are conventional and well known in the art.

Typically, the amount of the further components as defined above, when present, is from 0.1 wt. % to 20 wt. %, more preferably from 0.1 wt. % to 15 wt. %, most preferably from 0.1 wt. % to 10 wt. %, relative to the total weight of the polymer composition.

### Polymer Composition

Whilst it is within the ambit of the invention for the polymer composition to comprise other polymer components in addition to the LDPE, polypropylene and the styrene block copolymer, it is preferable if the polymer composition consists essentially of the LDPE, polypropylene and styrene block copolymer as the only polymer components.

It will be appreciated that the polymer composition further contains the nanoparticle filler (iv) and may further contain further components, such as standard polymer additives as discussed in more detail above.

The term “consists essentially of” implies the exclusion of any other polymer component but allows for the presence of further components such as additives (which may be part of a masterbatch).

It is understood that, in general, the combined weight percentages of components (i), (ii), (iii) and (iv) add up to 100 wt. %. However, this does not exclude the presence of further components, as described above. When further components are present, the combined weight percentages of the further components and the components (i), (ii), (iii), (iv) add up to 100 wt. %.

It is further understood that all definitions and preferences, as described above, equally apply for all further embodiments, as described below.

In a preferred embodiment, the invention provides a polymer composition comprising
(i) 4.5 to 95.0 wt. % low density polyethylene (LDPE);
(ii) 4.5 to 95.0 wt. % of a polypropylene; and
(iv) 0.5 to 10.0 wt. % of an aliphatic, preferably alkyl, functionalized inorganic nanoparticle filler;
whereby the weight percentages (wt. %) are expressed relative to the total weight of the polymer composition.

In a preferred embodiment, the invention provides a polymer composition comprising
(i) 4.0 to 95.0 wt. % low density polyethylene (LDPE);
(ii) 4.0 to 95.0 wt. % of a polypropylene; and
(iii) 0.5 to 30.0 wt. % of a styrene block copolymer;
(iv) 0.5 to 10.0 wt. % of an aliphatic, preferably alkyl, functionalized inorganic nanoparticle filler;
whereby the weight percentages (wt. %) are expressed relative to the total weight of the polymer composition.

In a preferred embodiment, the invention provides a polymer composition comprising
(i) 35 to 75.0 wt. % low density polyethylene (LDPE);
(ii) 20.0 to 40.0 wt. % of a polypropylene; and
(iv) 1.0 to 8.0 wt. % of an aliphatic, preferably alkyl, functionalized inorganic nanoparticle filler;
whereby the weight percentages (wt. %) are expressed relative to the total weight of the polymer composition.

In a preferred embodiment, the invention provides a polymer composition comprising
(i) 35 to 75.0 wt. % low density polyethylene (LDPE);
(ii) 20.0 to 40.0 wt. % of a polypropylene; and
(iii) 4.0 to 25.0 wt. % of a styrene block copolymer; and
(iv) 1.0 to 8.0 wt. % of an aliphatic, preferably alkyl, functionalized inorganic nanoparticle filler;
whereby the weight percentages (wt. %) are expressed relative to the total weight of the polymer composition.

In a preferred embodiment, the invention provides a polymer composition comprising
(i) 35 to 75.0 wt. % LDPE homopolymer;
(ii) 20.0 to 40.0 wt. % of a polypropylene homopolymer; and
(iii) 0.0 to 25.0 wt. % of a styrene block copolymer; and
(iv) 1.0 to 8.0 wt. % of an aliphatic, preferably alkyl, functionalized inorganic nanoparticle filler;
whereby the weight percentages (wt. %) are expressed relative to the total weight of the polymer composition.

In a preferred embodiment, the invention provides a polymer composition comprising
(i) 35 to 75.0 wt. % LDPE homopolymer;
(ii) 20.0 to 40.0 wt. % of a polypropylene homopolymer; and
(iii) 0.0 to 20.0 wt. % of a poly[styrene-b-(ethylene-co-butylene)-b-styrene](SEBS), Poly[styrene-b-(ethylene-co-propylene)-b-styrene] (SEPS), Poly[styrene-b-(butadiene)-b-styrene] (SBS) and Poly[styrene-b-(isoprene)-b-styrene] (SIS), preferably SEBS; and
(iv) 1.0 to 8.0 wt. % of an aliphatic, preferably alkyl, functionalized inorganic nanoparticle filler;
whereby the weight percentages (wt. %) are expressed relative to the total weight of the polymer composition.

In one embodiment, the invention provides a polymer composition comprising a combined total of at least 30 wt. %, preferably at least 40 wt. %, more preferably at least 50 wt. %, even more preferably at least 60 wt. % of components (i), (ii) and (iii), whereby the weight percentages (wt. %) are expressed relative to the total weight of the polymer composition.

In any of the above embodiments the use of peroxide can be markedly reduced or completely avoided.

Hence, the polymer composition of the invention is preferably substantially free of peroxide (e.g. comprises less than 0.5 wt. % peroxide, preferably less than 0.1 wt. % peroxide, such as less than 0.05 wt. % peroxide, relative to the total weight of the composition). Even more preferably, the polymer composition is free of any peroxide (i.e. contains 0 wt. % peroxide, relative to the total weight of the composition) and most preferably free of any radical forming agent.

In one embodiment, the composition is thermoplastic. Thus, the composition of the invention is preferably not crosslinked.

The polymer composition of the invention preferably has a DC conductivity of 0.5 to 10 fS/m when measured after 18 hrs at 30 kV/mm and a temperature of 70° C., preferably 0.5 to 6.0 fS/m, more preferably 0.5 to 4 fS/m, even more preferably 0.5 to 3.5 fS/m.

The DC conductivity is measured according to the “DC-conductivity measurement” as described under “Determination methods”.

In a preferred embodiment, the polymer composition has a storage modulus (E′) determined according to the method described under “Experimental Part” of at least 5.0×10⁶ Pa at 120° C., more preferably at least 1.0×10⁷ Pa at 120° C.

In a preferred embodiment the polymer composition has a storage modulus (E′) determined according to the method described under “Experimental Part” of at least 1.0×10⁶ Pa at 140° C., more preferably at least 5.0×10⁶ Pa at 140° C.

### Process

In one aspect, the present invention provides a process for the preparation of the polymer composition as defined herein. It is further understood that all definitions and preferences, as described above, equally apply for all further embodiments, as described below.

The process comprises blending:
(i) 4.95 to 95.0 wt. % low density polyethylene (LDPE);
(ii) 4.95 to 95.0 wt. % of a polypropylene; and
(iii) 0.00 to 25.0 wt. % of a styrene block copolymer;
(iv) 0.05 to 10.0 wt. % of an aliphatic, preferably alkyl, functionalized inorganic nanoparticle filler;

whereby the weight percentages (wt. %) are expressed relative to the total weight of the polymer composition.

During manufacture of the polymer composition, the components can be blended, e.g. melt mixed in an extruder.

Typically, said process will be carried out by compounding by, for example, extrusion. Preferably, said process does not involve the use of peroxide. As a result of this the process for preparing the polymer composition of the invention typically does not comprise a degassing step.

Typically, the process involves heating to a temperature of at least 150° C., preferably at least 160° C., such as at least 170° C. The process will generally involve heating to 300° C. or less, such as 250° C. or less.

In one embodiment, the process comprises the further step of crosslinking the polymer composition. Crosslinking may be effected by any conventional means as well known in the art, such as peroxide crosslinking, more particularly organic peroxide crosslinking such as crosslinking with dicumylperoxide. Preferably the polymer composition is not crosslinked.

### Cable

In one aspect, the present invention provides a cable, typically a power cable such as an AC cable or a DC cable, comprising the polymer composition as defined herein. It is further understood that all definitions and preferences, as described above, equally apply for all further embodiments, as described below.

A power cable is defined to be a cable transferring energy operating at any voltage level, typically operating at voltages higher than 1 kV. The power cable can be a low voltage (LV), a medium voltage (MV), a high voltage (HV) or an extra high voltage (EHV) cable, which terms, as well known, indicate the level of operating voltage.

The polymer composition is even more preferably used in the insulation layer for a DC power cable operating at voltages higher than 36 kV, such as a HVDC cable. For HVDC cables the operating voltage is defined herein as the electric voltage between ground and the conductor of the high voltage cable.

Preferably the HVDC power cable of the invention is one operating at voltages of 40 kV or higher, even at voltages of 50 kV or higher. More preferably, the HVDC power cable operates at voltages of 60 kV or higher. The invention is also highly feasible in very demanding cable applications and further cables of the invention are HVDC power cable operating at voltages higher than 70 kV. Voltages of 100 kV or more are targeted, such as 200 kV or more, more preferably 300 kV or more, especially 400 kV or more, more especially 500 kV or more. Voltages of 640 kV or more, such as 700 kV are also envisaged. The upper limit is not limited. The practical upper limit can be up to 1500 kV, such as 1100 kV. The cables of the invention operate well therefore in demanding extra HVDC power cable applications operating 400 to 850 kV, such as 650 to 850 kV.

A cable, such as a power cable (e.g. a DC power cable) comprises one or more conductors surrounded by at least one layer. The polymer composition of the invention may be used in that at least one layer. Preferably, the cable comprises an inner semiconductive layer, an insulation layer and an outer semiconductive layer, in that order.

The polymer composition of the invention is preferably used in the insulation layer of the cable. Ideally, the at least one layer, preferably the insulation layer comprises at least 95 wt. %, such as at least 98 wt. % of the polymer composition of the invention, such as at least 99 wt. %, relative to the total weight of the layer as a whole. Ideally the layer consists of the polymer composition. It is preferred therefore if the polymer composition of the invention is the only non-additive component used in the insulation layer of the cables of the invention. The term consists essentially of is used herein to mean that the only polymer composition present is that defined herein. It will be appreciated that the insulation layer may contain standard polymer additives such as water tree retarders, antioxidants and so on. These are not excluded by the term “consists essentially of”. Note also that these additives may be added as part of a masterbatch and hence carried on a polymer carrier. The use of masterbatch additives is not excluded by the term consists essentially of. Such a layer is preferably free of peroxide.

This cable layer of the invention preferably has a DC conductivity of 0.5 to 10 fS/m when measured after 18 hrs at 30 kV/mm and a temperature of 70° C., preferably 0.5 to 6.0 fS/m, more preferably 0.5 to 4 fS/m, even more preferably 0.5 to 3.5 fS/m.

It is preferred if the insulation layer comprises no crosslinking agent. The insulation layer is thus ideally free of peroxides and hence free of by-products of the decomposition of the peroxide.

Naturally, the non-cross-linked embodiment also simplifies the cable production process. Also, it is generally required to degas a cross-linked cable layer to remove the by-products of these agents after crosslinking. Where these are absent, no such degassing step is required.

The insulation layer may contain, in addition to the polymer composition of the invention further component(s) such as additives, e.g. antioxidant(s), scorch retarder(s) (SR), crosslinking booster(s), stabiliser(s), processing aid(s), flame retardant additive(s), water tree retardant additive(s), acid or ion scavenger(s), inorganic filler(s), dielectric liquids and voltage stabilizer(s), as known in the polymer field. Typically, however, no scorch retarder will be present.

The insulation layer may therefore comprise conventionally used additive(s) for W&C applications, such as one or more antioxidant(s). As non-limiting examples of antioxidants e.g. sterically hindered or semi-hindered phenols, aromatic amines, aliphatic sterically hindered amines, organic phosphites or phosphonites, thio compounds, and mixtures thereof, can be mentioned.

Preferably, the insulation layer does not comprise a carbon black. Also preferably, the insulation layer does not comprise flame retarding additive(s), e.g. a metal hydroxide containing additives in flame retarding amounts.

The used amounts of additives are conventional and well known to a skilled person, e.g. 0.1 to 1.0 wt. %.

The cable of the invention also typically contains inner and outer semiconductive layers. These can be made of any conventional material suitable for use in these layers. The inner and the outer semiconductive layers can be different or identical and may comprise a polymer(s) which is preferably a polyolefin or a mixture of polyolefins and a conductive filler, preferably carbon black. Suitable polyolefin(s) are e.g. polyethylene produced in a low pressure process (LLDPE, MDPE, HDPE), polyethylene produced in a HP process (LDPE) or a polypropylene. In one embodiment, the polymer composition of the invention can be used in the manufacture of the inner and/or outer semiconductive layers.

The inner and outer semiconductive layers may comprise carbon black. The carbon black can be any conventional carbon black used in the semiconductive layers of a power cable, preferably in the semiconductive layer of a power cable. Preferably the carbon black has one or more of the following properties: a) a primary particle size of at least 5 nm which is defined as the number average particle diameter according ASTM D3849-95a, dispersion procedure D b) iodine number of at least 30 mg/g according to ASTM D1510, c) oil absorption number of at least 30 ml/100 g which is measured according to ASTM D2414. Non-limiting examples of carbon blacks are e.g. acetylene carbon black, furnace carbon black and Ketjen carbon black, preferably furnace carbon black and acetylene carbon black. Preferably, the semiconductive layer(s) comprises 10 to 50 wt. % carbon black, based on the total weight of the layer.

In one embodiment, the outer semiconductive layer is cross-linked. In another embodiment, the inner semiconductive layer is preferably non-cross-linked. Overall it is preferred if the inner and outer semiconductive layers and the insulation layer remain non cross-linked. It is however possible that the inner semiconductive layer and the insulation layer remain non cross-linked where the outer semiconductive layer is cross-linked. A peroxide crosslinking agent can therefore be provided in the outer semiconductive layer only.

The conductor typically comprises one or more wires. Moreover, the cable may comprise one or more such conductors. Preferably the conductor is an electrical conductor and comprises one or more metal wires. Cu or Al wire is preferred.

As well known the cable can optionally comprise further layers, e.g. screen(s), a jacketing layer(s), other protective layer(s) or any combinations thereof.

### Cable Manufacture

The invention also provides a process for producing a cable comprising the steps of applying on one or more conductors, preferably by (co)extrusion, an inner semiconductive layer, an insulation layer and an outer semiconductive layer, in that order, wherein the insulation layer comprises the composition of the invention. It is further understood that all definitions and preferences, as described above, equally apply for all further embodiments, as described below.

The process may optionally comprise the steps of crosslinking one or both of the inner semiconductive layer or outer semiconductive layer, without crosslinking the insulation layer. Overall it is preferred if the inner and outer semiconductive layers and the insulation layer remain non cross-linked.

More preferably, a cable is produced, wherein the process comprises the steps of
(a)—providing and mixing, preferably melt mixing in an extruder, an optionally crosslinkable first semiconductive composition comprising a polymer, a carbon black and optionally further component(s) for the inner semiconductive layer,
providing and mixing, preferably melt mixing in an extruder, the polymer composition of the invention; and
providing and mixing, preferably melt mixing in an extruder, a second semiconductive composition which is optionally crosslinkable and comprises a polymer, a carbon black and optionally further component(s) for the outer semiconductive layer,
(b) applying on one or more conductors, preferably by coextrusion,
a melt mix of the first semiconductive composition obtained from step (a) to form the inner semiconductive layer,
a meltmix of polymer composition of the invention obtained from step (a) to form the insulation layer, and
a meltmix of the second semiconductive composition obtained from step (a) to form the outer semiconductive layer, and
(c) optionally crosslinking at crosslinking conditions one or both of the first semiconductive composition of the inner semiconductive layer and the second semiconductive composition of the outer semiconductive layer, of the obtained cable, and/or the insulation layer.

Alternatively, in step (c) both of the first semiconductive composition of the inner semiconductive layer and the second semiconductive composition of the outer semiconductive layer, of the obtained cable, and the insulation layer are crosslinked.

Melt mixing means mixing above the melting point of at least the major polymer component(s) of the obtained mixture and is carried out for example, without limiting to, in a temperature of at least 15° C. above the melting or softening point of polymer component(s).

The term “(co)extrusion” means herein that in case of two or more layers, said layers can be extruded in separate steps, or at least two or all of said layers can be coextruded in a same extrusion step, as well known in the art. The term “(co)extrusion” means herein also that all or part of the layer(s) are formed simultaneously using one or more extrusion heads. For instance a triple extrusion can be used for forming three layers. In case a layer is formed using more than one extrusion heads, then for instance, the layers can be extruded using two extrusion heads, the first one for forming the inner semiconductive layer and the inner part of the insulation layer, and the second head for forming the outer insulation layer and the outer semiconductive layer.

As well known, the polymer composition of the invention and the optional and preferred first and second semiconductive compositions can be produced before or during the cable production process.

Preferably, the polymers required to manufacture the cable of the invention are provided to the cable production process in form of powder, grain or pellets. Pellets mean herein generally any polymer product which is formed from reactor-made polymer (obtained directly from the reactor) by post-reactor modification to solid polymer particles.

Accordingly, the components can be premixed, e.g. melt mixed together and pelletized, before mixing. Alternatively, and preferably, these components can be provided in separate pellets to the (melt) mixing step (a), where the pellets are blended together.

The (melt) mixing step (a) of the provided polymer composition of the invention and of the preferable first and second semiconductive compositions is preferably carried out in a cable extruder. The step a) of the cable production process may optionally comprise a separate mixing step, e.g. in a mixer arranged in connection and preceding the cable extruder of the cable production line. Mixing in the preceding separate mixer can be carried out by mixing with or without external heating (heating with an external source) of the component(s).

Any crosslinking agent can be added before the cable production process or during the (melt) mixing step (a). For instance, and preferably, the crosslinking agent and also the optional further component(s), such as additive(s), can already be present in the polymers used. The crosslinking agent is added, preferably impregnated, onto the solid polymer particles, preferably pellets.

It is preferred that the melt mix of the polymer composition obtained from (melt)mixing step (a) consists of the LDPE (i), polypropylene (ii) and optionally the styrene block copolymer (iii) as the sole polymer components. The component (iv) and the optional and preferable additive(s) can be added to polymer composition as such or as a mixture with a carrier polymer, i.e. in a form of a master batch.

The crosslinking of other layers can be carried out at increased temperature which is chosen, as well known, depending on the type of crosslinking agent. For instance temperatures above 150° C., such as from 160 to 350° C., are typical, however without limiting thereto.

The processing temperatures and devices are well known in the art, e.g. conventional mixers and extruders, such as single or twin screw extruders, are suitable for the process of the invention.

The thickness of the insulation layer of the cable, more preferably of the power cable is typically 2 mm or more, preferably at least 3 mm, preferably of at least 5 to 100 mm, more preferably from 5 to 50 mm, and conventionally 5 to 40 mm, e.g. 5 to 35 mm, when measured from a cross section of the insulation layer of the cable.

The thickness of the inner and outer semiconductive layers is typically less than that of the insulation layer, and in power cables can be e.g. more than 0.1 mm, such as from 0.3 up to 20 mm, e.g. 0.3 to 10 mm of inner semiconductive and outer semiconductive layer. The thickness of the inner semiconductive layer is preferably 0.3-5.0 mm, preferably 0.5-3.0 mm, preferably 0.8-2.0 mm. The thickness of the outer semiconductive layer is preferably from 0.3 to 10 mm, such as 0.3 to 5 mm, preferably 0.5 to 3.0 mm, preferably 0.8-3.0 mm. It is evident for and within the skills of a skilled person that the thickness of the layers of the power cable depends on the intended voltage level of the end application cable and can be chosen accordingly.

The invention will now be described with reference to the following non limiting examples and figures.

### BRIEF DESCRIPTION OF THE FIGURES

FIG. 1 shows the conductivity of the samples disclosed in Table 1 as a function of temperature. The inventive examples comprising LDPE (i), polypropylene (ii) optionally the styrene block copolymer (iii) and the nanoparticle filler (iv) have significantly lower conductivity than the comparative examples consisting of LDPE (i), alone, or LDPE+nanoparticle filler alone.

FIG. 2 shows the storage modulus (E′) of the samples disclosed in Table 1 as a function of temperature.

### Experimental Part

Unless otherwise stated in the description or experimental part the following methods were used for the property determinations:
(wt. %=% by weight)

### Density

The density of the polymer samples was measured according to ISO 1183-2.

### Molecular Weight (M_{w})

The molecular weight (weight-average molecular weight M_{w}) and the polydispersity index, as well as the branching ratio were determined with size exclusion chromatography (SEC) using an Agilent PL-GPC 220 system, in 1,3,4-trichlorobenzene at 150 8C; universal calibration with polystyrene standards.

### Melt Flow Rate (MFR)

The melt flow rate (MFR) is determined according to ISO 1133 and is indicated in g/10 min. The MFR is an indication of the flowability, and hence the processability, of the polymer. The higher the melt flow rate, the lower the viscosity of the polymer. Unless otherwise specified, the term MFR as used herein refers to MFR₂. The MFR₂ of polypropylene is determined at a temperature of 230° C. and a load of 2.16 kg. The MFR₂ of polyethylene is determined at a temperature of 190° C. and a load of 2.16 kg.

### DC-Conductivity Measurement

Prior to the measurements, the 0.3 mm thick film samples were dried for 24 h at 70° C. in a vacuum oven and stored in a desiccator between drying and DC measurement. The DC test cell consisted of a three-electrode setup (measuring area of Ø=60 mm), placed in an oven at 70° C. and connected to a high-voltage power supply (Glassman FJ60R2). The samples were placed in the measurement cell one hour before the measurements in order to assure that the desired temperature of 70° C. was reached. A DC voltage of 9 kV was applied across the 0.3 mm thick specimen films (30 kV/mm) for 19 h. DC conductivity (σ_{DC}) was calculated based on the leakage currents obtained after 18 h. The volume leakage current was recorded with a Keithley 6517B electrometer, and dynamically averaged. In addition, a low pass filter was added into the circuit at the high voltage side for limiting the current in case of specimen breakdown and for filtering out high frequency noise.

### Storage Modulus (E′)

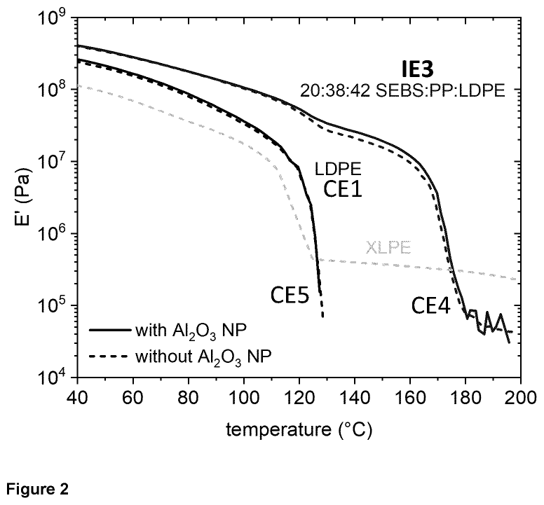

Dynamic mechanical analysis (DMA) was carried out using a TA Q800 DMA in tensile mode on 35 mm times 6 mm large pieces cut from 1.9 mm thick melt-pressed films. Variable-temperature measurements were done at a heating rate 3° C. min⁻¹, with a maximum strain of 0.05% and a frequency of 0.5 Hz. The results are shown in FIG. 2.

### Materials

The materials used in this work are as follows:

Component (i): LDPE homopolymer with a MFR˜ 2 g/10 min (190° C./2.16 kg) was obtained from Borealis AB (M_{w}˜117 kg mol⁻¹, PDI˜9, number of long-chain branches˜1.9).

Component (ii): iPP—isotactic polypropylene with a MFR˜3.3 g/10 min (230° C./2.16 kg) was obtained from Borealis AB (M_{w}˜411 kg mol⁻¹, PDI˜8.5).

Component (iii): Poly[styrene-b-(ethylene-co-butylene)-b-styrene] (SEBS) with MFI˜<1 g/10 min. (230° C./2.16 kg, measured according ASTM D 1238) and 18.5-22.5% polystyrene content was obtained from Kraton Corporation (Kraton G1642 HU).

Component (iv), C₈—Al₂O₃: Preparation method described below

### Preparation of Component (iv)

Aluminium oxide nanoparticles (Nanodur from Nanophase Inc, CAS number 1344-28-01, density 3.97 g/cm³) were coated with n-octyltriethoxysilane (Sigma-Aldrich, CAS-number 3069-42-9). The reactions were conducted in a mixed medium of 2-propanol and water. Ammonia hydroxide (aq. 25%) was used as a catalyst to promote the hydrolysis and the condensation of the silanes. After surface modification, the nanoparticles were dried for 20 h at 80° C. in a vacuum oven (Fisher Scientific Vacucell, MMT group). The average diameter of the spherical Al₂O₃ nanoparticles was 50 nm, according to TEM image analysis.

### Preparation of the Polymer Compositions:

Component (iv) according to the present invention and as used in the inventive examples, octyl-coated aluminium oxide nanoparticles (C8-Al₂O₃), was dispersed in n-heptane (0.3 ml n-heptane/1 g polymer) and ultrasonicated for 5 minutes, whereafter 0.02 wt. % antioxidant Irganox 1076 (Ciba Speciality Chemicals, CAS number 2082-79-3) was added. Low-density polyethylene (LDPE) was added to the nanoparticle suspensions, resulting in a solid content of 3 wt. % C8-Al₂O₃ nanoparticles and 97 wt. % LDPE. The LDPE:C8-Al₂O₃ slurry was shaken for 1 h with a Vortex Genie 2 shaker (Scientific Instruments Inc) and dried overnight at 80° C. After drying, the powder was shaken for another 30 min and then compounded for 6 min at 150° C. and 100 rpm (Micro 15 cc twin screw compounder, Xplore instruments). The extrudate was cut into 2-3 mm long pellets.

The pelletized LDPE:C8-Al₂O₃ nanocomposite was dried for 17 h at 80° C. in a vacuum oven. Polymer compositions according to the present invention were prepared by compounding different combinations of SEBS, iPP and the LDPE:C8-Al₂O₃ nanocomposite containing 3 wt. % C8-Al₂O₃, as indicated in Table 1 below, with an Xplore Micro Compounder MC5 under nitrogen gas for 4 min at 200° C. with a screw speed of 70 rpm followed by extrusion with a die temperature of 210° C. Extrudates were melt-pressed into 0.3 mm thick films for electrical measurements and 1.9 mm thick films for mechanical analysis using a LabPro 200 Fontijne press at 200° C. by applying a pressure of 150 kPa for 1 min followed by cooling at a rate of −10° C./min.

The polymer compositions of the comparative examples were prepared in a similar way as the inventive examples wherein neat LDPE was compounded with, iPP, SEBS and the LDPE:C8-Al₂O₃ nanocomposite containing 3 wt. % C8-Al₂O₃, as indicated in Table 1 below.

### Results

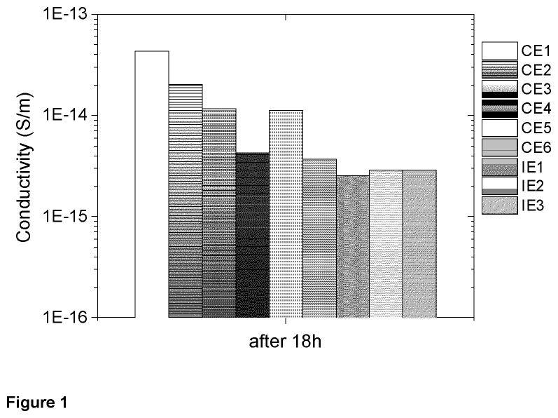

The composition and properties of samples of the polymer compositions according to the present invention (IE1-3) and samples of comparative compositions (CE1-6) are shown in Table 1. The DC-conductivity of each sample at each temperature is shown graphically in FIG. 1.

TABLE 1

| | LDPE | iPP | SEBS | C₈—Al₂O₃ | Temperature | DC conductivity |
|---|---|---|---|---|---|---|
| Example | (wt. %) | (wt. %) | (wt. %) | (wt. %) | (° C.) | (S/m) |
| CE1 | 100 | | | | 70 | 4.35E−14 |
| CE2 | 75 | 25 | | | 70 | 2.01E−14 |
| CE3 | 71 | 24 | 5 | | 70 | 1.16E−14 |
| CE4 | 42 | 38 | 20 | | 70 | 4.26E−15 |
| CE5 | 98.74 | | | 1.26 | 70 | 1.12E−14 |
| CE6 | 97.7 | | | 2.3 | 70 | 3.67E−15 |
| IE1 | 72.75 | 25 | | 2.25 | 70 | 2.54E−15 |
| IE2 | 68.87 | 24 | 5 | 2.13 | 70 | 2.89E−15 |
| IE3 | 40.74 | 38 | 20 | 1.26 | 70 | 2.90E−15 |

The inventors have established that the inventive compositions have excellent (i.e. low) DC-conductivity. With reference to the data in Table 1 and FIG. 1, it can be seen that the DC-conductivity of the inventive compositions IE1-3 is unexpectedly more than an order of magnitude lower than the neat LDPE composition of CE1.

Surprisingly, the conductivity of the inventive examples is also significantly reduced relative to that of blends consisting of LDPE, iPP and SEBS (CE2-4) or LDPE and nanoparticle filler (CE5-6) alone. The reduction in DC conductivity may even be synergistic.

It is surprising that the conductivity of the polymer composition of the invention is so low given that the mechanism of conduction is different for the LDPE/iPP or LDPE/iPP/SEBS blends and the LDPE/Al₂O₃ system. There is therefore no expectation that the conductivity of the combined polymer composition should be lower than the comparative examples.

Furthermore, this reduction in DC conductivity is obtained whilst at least maintaining the thermomechanical properties of the polymer composition (e.g. in terms of storage modulus). This is despite the presence of the nanoparticle filler which might be expected to reduce thermomechanical performance. Without being bound to this theory, the inventors believe that the introduction of PP and SEBS to LDPE creates a system that is melt miscible and phase separates. This leads to the formation of domains of PP and SEBS that give the system far better thermomechanical properties. The introduction of the nanoparticles might be expected to disturb this fine balance but surprisingly this is not the case. Analysis of the blends suggests that the thermomechanical properties of the inventive examples are at least maintained relative to the comparative examples (see FIG. 2).

The low conductivity of the compositions according to the present invention makes them particularly suitable for use in applications where low conductivity is essential, such as in the insulation layer of power cables.

1. A polymer composition comprising:
(i) 4.95 to 95.0 wt. % low density polyethylene (LDPE) (component (i), herein after);
(ii) 4.95 to 95.0 wt. % of a polypropylene (component (ii), herein after); and
(iii) 0.00 to 30.0 wt. % of a styrene block copolymer (component (iii), herein after);
(iv) 0.05 to 10.0 wt. % of an aliphatic functionalized inorganic nanoparticle filler (component (iv), herein after);
whereby the weight percentages (wt. %) are expressed relative to the total weight of the polymer composition.

2. The polymer composition as claimed in claim 1, wherein the nanoparticle filler component (iv) comprises inorganic oxide nanoparticles.

3. The polymer composition as claimed in claim 1, wherein the nanoparticle filler component (iv) comprises aluminium oxide, magnesium oxide, zinc oxide nanoparticles and mixtures thereof.

4. The polymer composition as claimed in claim 1, wherein the nanoparticle filler component (iv) comprises aluminium oxide nanoparticles.

5. The polymer composition as claimed in claim 1, wherein the aliphatic group of component (iv) is a C1-20 alkyl group.

6. The polymer composition as claimed in claim 1, wherein the nanoparticle filler component (iv) is functionalised by reaction with an alkylsilane.

7. The polymer composition as claimed in claim 1, wherein:
the LDPE component (i) is a low-density polyethylene homopolymer;
the polypropylene component (ii) is a propylene homopolymer;
the styrene block copolymer component (iii) is selected from the group consisting of Poly[styrene-b-(ethylene-co-butylene)-b-styrene] (SEBS), Poly[styrene-b-(ethylene-co-propylene)-b-styrene] (SEPS), Poly[styrene-b-(butadiene)-b-styrene] (SBS) and Poly[styrene-b-(isoprene)-b-styrene] (SIS), and mixtures thereof;
or a combination thereof.

8. The polymer composition as claimed in claim 1, wherein the polymer composition has a DC conductivity of 0.5 to 10 fS/m when measured after 18 hrs at 30 kV/mm and a temperature of 70° C., following the DC-conductivity measurement method in the description above.

9. The polymer composition as claimed in claim 1, which is not crosslinked.

10. The polymer composition as claimed in claim 1, the polymer composition comprising:
(i) 35 to 75.0 wt. % LDPE homopolymer component (i);
(ii) 20.0 to 40.0 wt. % of polypropylene homopolymer component (ii); and
(iii) 0.0 to 25.0 wt. % of styrene block copolymer component (iii); and
(iv) 1.0 to 8.0 wt. % of aliphatic functionalized inorganic nanoparticle filler component (iv);
whereby the weight percentages (wt. %) are expressed relative to the total weight of the polymer composition.

11. A process for the preparation of the composition as claimed in claim 1, wherein the method comprises blending:
(i) 4.95 to 95.0 wt. % low density polyethylene (LDPE) (component (i), herein after);
(ii) 4.95 to 95.0 wt. % of polypropylene (component (ii), herein after); and
(iii) 0.00 to 30.0 wt. % of styrene block copolymer (component (iii), herein after);
(iv) 0.05 to 10.0 wt. % of aliphatic functionalized inorganic nanoparticle filler (component (iv), herein after);
whereby the weight percentages (wt. %) are expressed relative to the total weight of the polymer composition.

12. A cable comprising a conductor surrounded by one or more layers, wherein one or more of said layers comprises the polymer composition as defined in claim 1.

13. A power cable comprising a conductor which is surrounded at least by an inner semiconductive layer, an insulation layer and an outer semiconductive layer, in that order, wherein at least one layer, comprises the polymer composition according to claim 1.

14. The power cable as claimed in claim 13, wherein the power cable is a high voltage (HV) power cable or an ultra-high voltage (UHV) power cable.

15. A method of use of the polymer composition as claimed in claim 1, wherein the method comprises using the polymer composition in the manufacture of a layer in a cable.

16. The polymer composition of claim 1, wherein the aliphatic group of component (iv) is a linear C1-20 alkyl group.

17. The polymer composition of claim 1, wherein the aliphatic group of component (iv) is a C6-C12 alkyl group.

18. The polymer composition of claim 6, wherein the alkylsilane is alkyl(trialkoxy)silane or dialkyl(dialkoxy)silane.

19. The polymer composition of claim 1, wherein:
the LDPE component (i) is a low-density polyethylene homopolymer;
the polypropylene component (ii) is a an isotactic polypropylene homopolymer;
the styrene block copolymer component (iii) is Poly[styrene-b-(ethylene-co-butylene)-b-styrene] (SEBS) and mixtures thereof,
or a combination thereof.

20. The power cable of claim 13, wherein the power cable is a direct current (DC) power cable, wherein at least the insulation layer comprises the polymer composition, or a combination thereof.
